(19) United States
(12) Patent Application Publication
(10) Pub. No.: US 2004/0161655 A1
(43) Pub. Date: Aug. 19, 2004

(54) Adhesively bonded electrochemical cell stacks

(76) Inventors: Oliver J. Murphy, Bryan, TX (US); Craig Andrews, College Station, TX (US); James Layton, Bryan, TX (US); Charles J. Greenwald, Bryan, TX (US); Chris Boyer, Houston, TX (US)

Correspondence Address: STREETS & STEELE, 13831 NORTHWEST FREEWAY, SUITE 355, HOUSTON, TX, 77040, US

(21) Appl. No.: 10/727,836

(22) Filed: Dec. 4, 2003

Related U.S. Application Data
(60) Provisional application No. 60/431,010, filed on Dec. 4, 2002.

(51) Int. Cl. B32B 31/00; H01M 2/08

(52) U.S. Cl. 429/36; 156/292

(57) ABSTRACT

A method for assembling electrochemical cells for monopolar arrays or bipolar stacks using an adhesive to bond and seal the interfaces of the stack components. Adhesives may bond and seal the components of an electrochemical cell stack, thereby providing a much lighter assembly than those stacks using traditional assembly methods and techniques. Accordingly, no gaskets, o-rings or similar devices are required to seal between the components. The adhesive may be an adhesive type selected from types consisting of reactively cured, thermoplastic, and cured by solvent loss. The adhesive may be an epoxy having a harness (Shore A) of between about 90 and about 70, preferably about 80. The perimeters of the membrane that is part of a membrane and electrode assembly may be dimensionally stabilized by leaving the perimeter in the PFSP form, or by converting the protonated perimeter to a tetra-alkyl ammonium form or to a polyvalent cationic form.

This application claims priority to U.S. Provisional Patent Application No. 60/431,010 filed on Dec. 4, 2002.

### BACKGROUND OF THE INVENTION

1. Field of the Invention

The present invention provides a method for assembling electrochemical cell stacks.

2. Description of the Related Art

Conventional construction of fuel cell and electrolyzer stacks, especially proton exchange membrane (PEM) stacks, requires a large number of substantially flat or planar components, including bipolar plates, membrane and electrode assemblies, and optionally, cooling plates, to be assembled between a pair of heavy metal endplates. A membrane and electrode assembly (MEA) comprises an anode electrode and a cathode electrode attached to opposite sides of a solid polymer electrolyte. The entire assembly is placed in compression, much like a filter press, through the use of a series of long rods, often called tie rods and typically being threaded metal rods, extending from one endplate of the assembly to the other endplate with nuts or other fasteners on either end. The compression forces exerted through the tie rods normally compress a gasket, o-ring or similar device that is inserted between the sealing surfaces, thereby sealing any gases or liquids inside the electrochemical cell stack.

While conventional “filter press” designs may be straightforward and effective, they are also bulky and heavy. In conventional filter press designs, the bolts along the edges of the stack apply the entire compressive load. In order to compress the stack as evenly as possible over the cross-sectional area of the stack without bending the endplates, the endplates must be very thick. While increasing the thickness of the end plates may help make them rigid, the increased thickness also results in an increased total weight of the electrochemical cell stack. Another contributing factor to the increased weight in the filter press design is the necessity to place the tie rods around the perimeter of the active portion of the stack, thereby requiring endplates that are even larger in area than the stack.

The size of the end plates can be marginally reduced by placing the tie rods inside of gas or liquid passages, and therefore, inside the area of the bipolar plates. While this design allows reduction in electrochemical cell stack-weight, the extent of the reduction is limited by the continuing need for heavy rods and rigid endplates.

An electrochemical cell stack typically has a number of flat components including the electrodes, which are normally attached to proton exchange membranes, and components that provide flow paths for the reactant fluids, any cooling fluids, and the electrons and protons that are consumed or liberated during the electrochemical reactions. Each of the fluid streams must remain separated from the other fluid streams as well as remain tightly sealed within the electrochemical cell stack so as not to leak to the outside environment.

Electrochemical cell stacks may be assembled using bipolar grids or bipolar plates. Bipolar grids are used in a monopolar electrochemical stack and are described by Cisar et al. in U.S. Pat. No. 6,024,228, which patent is incorporated herein by reference. Bipolar plates and current collectors are used in bipolar electrochemical stacks and, as used in the present invention, are described by Cisar et al. in U.S. Pat. No. 6,232,010, which patent is incorporated herein by reference. Bipolar grids and bipolar plates are bipolar elements.

An electrochemical cell stack has a series of membrane and electrode assemblies connected in series to each other. A membrane and electrode assembly comprises an anode electrode and a cathode electrode attached to opposite sides of a solid polymer electrolyte. The bipolar elements prevent the reaction fluids, which are flowing over the anode and the cathode electrodes of adjacent cells, from mixing.

There is a need for a method or system for assembling and sealing electrochemical cell stacks that does not add significant weight and volume to the stack. It would be beneficial if the method or system reduced the number of parts required to assemble an electrochemical cell stack. It would be of greater benefit if the method or system simplified the assembly process for electrochemical cell stacks.

### SUMMARY OF THE INVENTION

The present invention provides a method for assembling an electrochemical stack subassembly comprising adhesively bonding an anode side of a membrane and electrode assembly to an anode side of a bipolar element, and adhesively bonding a cathode side of the membrane and electrode assembly to a cathode side of an additional bipolar element, wherein an adhesive provides a fluid-tight seal between the bipolar element and the membrane and electrode assembly. The bipolar element may be selected from a bipolar plate or a bipolar grid. The method further comprises applying adhesive to a perimeter of a feature on the bipolar element, wherein the feature is selected from a flow field, a manifold, a channel, and combinations thereof.

To assemble a predetermined number of subassemblies, the method further includes adhesively bonding an anode side of an additional membrane and electrode assembly to an anode side of the other bipolar element, adhesively bonding a cathode side of the additional membrane and electrode assembly to a cathode side of an additional bipolar element, and then repeating these two steps until a pre-determined number of membrane and electrode assemblies have been adhesively bonded.

The membrane and electrode assembly comprises a solid polymer electrolyte membrane having a cathode electrode formed on a first side of the membrane and an anode electrode formed on a second side of the membrane. The solid electrolyte membrane is a material capable of conducting ions selected from single phase polymers, mixed phase polymers or matrix reinforced polymers.

A perimeter of the membrane and electrode assembly may be dimensionally stabilized. Dimensionally stabilizing the perimeter may comprise converting a central portion of a sheet of PFSF polymer to an acid form and forming an anode and a cathode on opposing sides of the central portion of the sheet. When the membrane is fully protonated, the step of dimensionally stabilizing the perimeter may comprise converting the perimeter of the membrane to a tetra-alkyl ammonium form by, for example, contacting the perimeter with an alcohol solution of a tetra-alkyl ammonium salt, wherein the tetra-alkyl ammonium is selected from symmetrical and asymmetrical structures. The tetra-alkyl ammonium salt may be a hydroxide or the slat may dissociate to a cation having a form (NR′R″R′″R″″)⁺, wherein R′, R″, R′″, and R″″ are identical, wherein R′ and R″ are identical and different from R′″ and R″″, or wherein R′, R″, R′″, R″″ are different from each other. The step of dimensionally stabilizing the perimeter may comprise converting the perimeter of the membrane to a polyvalent cationic form or contacting the perimeter with a basic solution of aluminum sulfate.

The method may further include bonding an additional layer of a membrane to the perimeter of at least one side of the membrane and electrode assembly, wherein the bonding is a process selected from hot pressing and applying an adhesive. The additional layer may be dimensionally stabilized if desired.

The bonding perimeters of the bipolar elements are of material selected from metal, carbon, electronically conductive polymers, conductive polymer composites or insulating polymers. The adhesive may be a silicone material, a polyurethane, and/or a thermoplastic selected from polyalkylenes, polyethylene containing copolymers, polypropylene, polypropylene containing copolymers, polyesters and polyarethanes.

The present invention further provides an electrochemical cell stack comprising a bipolar element, a membrane and electrode assembly, and an adhesive bond, wherein the adhesive bond provides a fluid-tight seal between the bipolar element and the membrane and electrode assembly. The bipolar element is selected from a bipolar plate, a bipolar grid, a heating plate, a cooling plate, and combinations thereof. A perimeter of the membrane and electrode assembly is dimensionally stabilized. The subassembly may further comprise an additional layer of a membrane, which may be dimensionally stabilized, to a perimeter on at least one side of the membrane and electrode assembly. The adhesive bond may be formed by an adhesive type selected from reactively cured, thermoplastic, and cured by solvent loss or by an epoxy having a hardness (Shore A) between about 90 and 70.

The foregoing and other objects, features and advantages of the invention will be apparent from the following more particular description of a preferred embodiment of the invention, as illustrated in the accompanying drawings wherein like reference numbers represent like parts of the invention.

### BRIEF DESCRIPTION OF THE DRAWINGS

FIG. 1 is an exploded view of an exemplary monopolar electrochemical cell stack assembly using bipolar grids that may be assembled using methods of the present invention.

FIGS. 2A-2B are plan views of two subassemblies.

FIG. 2C is a cross sectional view of FIGS. 2A and 2B.

FIG. 3 is an exploded view of the components of a monopolar fuel cell constructed without cell frames.

### DETAILED DESCRIPTION

The present invention provides a method for assembling one or more electrochemical cells for monopolar arrays or bipolar stacks using an adhesive to bond and seal the interfaces of the components of the stack. Adhesives, as provided in the present invention, may be used to bond and seal the components of an electrochemical cell stack, thereby providing a much lighter assembly than those stacks using traditional assembly methods and techniques. Accordingly, no gaskets, o-rings or similar devices are required to seal between the components.

In a monopolar array or stack, the non-active portion of the perimeter of one side or face of a membrane and electrode assembly is bonded with an adhesive to the perimeter of a first side or face of a first bipolar grid. Then the non-active portion of the perimeter of a second side or face of the membrane and electrode assembly is bonded with an adhesive to the perimeter of a first side or face of a second bipolar grid. The opposite sides or faces of the two bipolar grids are now available for bonding additional membrane and electrode assemblies. For example, the perimeter of the second face of the first bipolar grid may be bonded with an adhesive to the non-active perimeter of one side of a membrane and electrode assembly and the non-active perimeter of the second side of the membrane and electrode assembly may then be bonded with an adhesive to a third bipolar grid. This may continue until the desired numbers of electrochemical cells are connected together in series. The two cells on the ends (one at each end of the stack) may be completed with a bipolar grid only half as long as the others, each thereby spanning only one cell. The non-active perimeter of a membrane and electrode assembly includes the area having no electrode contacting the membrane and no protons passing therethrough.

When assembling an electrochemical cell into a stack configuration using bipolar plates, essentially the same procedure is followed. Heavy endplates are no longer required when assembling electrochemical stacks using the methods of the present invention. Instead, current collectors, as described in U.S. Pat. No. 6,232,010, and hereby fully incorporated by reference, are used because heavy strong end plates are not required to support compression forces. To assemble the electrochemical cell stack, a thin layer of adhesive is placed on the perimeter frame of a first current collector, which bonds to the non-active perimeter of a first side of a membrane and electrode assembly. A thin layer of adhesive is next placed on the perimeter frame of one side of a first bipolar plate and bonded to the second side of the non-active perimeter of the first membrane and electrode assembly. The non-active perimeter of a second membrane and electrode assembly is then bonded to the second side of the first bipolar plate and a second bipolar plate is then bonded to the non-active perimeter of the second side of the second membrane and electrode assembly. This procedure is repeated until the desired number of electrochemical cells are stacked in series and then the second current collector is bonded to the last membrane and electrode assembly, finishing the electrochemical cell stack assembly.

Whether the bipolar plate or the bipolar gird is used in assembling the stack, care must be taken to ensure that the membrane and electrode assemblies are oriented properly so that the cathode side of one membrane and electrode assembly faces the cathode side of a bipolar grid or bipolar plate to which the membrane and electrode assembly is being bonded. Furthermore, adhesive must be carefully applied to the perimeter of any features on the bipolar element, such as, for example, a flow field, a manifold, a channel and combinations thereof to provide the necessary fluidic seal keeping reactant fluids, cooling fluids, or heating fluids confined to their respective areas.

The adhesive may be any adhesive that bonds the materials being used in the electrochemical cell stack. Adhesives from all the major categories of adhesives may be used. The major categories of adhesives are considered to be reactively cured adhesives, thermoplastic adhesives and adhesives that cure by solvent loss. Reactively cured adhesives are those that transform from a fluid state to a solid state, but preferably not rigid state, by undergoing a chemical change. For example, two components that chemically react with each other may be mixed together, the chemical reaction causing the mix to solidify, with or without the addition of heat, with solidification occurring after the mix has been applied as an adhesive. Reactive curing can also occur by one or more components within the adhesive reacting with one or more components in the surroundings, such as air or moisture. Epoxies, silicones, and two-component polyurethanes fall into this broad category of adhesives.

Thermoplastic adhesives, or hot melt adhesives, are heated to soften them to allow application as an adhesive. After cooling, they solidify to form a bond. In the present invention, a thermoplastic adhesive must not soften at temperatures at or below the operating temperature of the electrochemical stack. Adhesives in this category are frequently based on, for example, polypropylene, polyethylene, copolymers of polyethylene and acrylic acid, ethyl vinyl acetates, polyamides, polyester and polyurethanes. Adhesives that cure by solvent loss include all the adhesives that consist of a tacky polymer dissolved in a volatile solvent, such as contact cement.

There are many specific types of adhesives that can be used to assemble fuel cell stacks. Among the reactively cured adhesives are epoxy type adhesives, especially resilient ones such as DURALCO 4538N®, a product of Cotronics Corporation of Buffalo, N.Y. Other examples of useful reactively cured adhesives are SYLGARD® 184, a two-part silicone elastomer, and Dow Corning 748™, a silicone sealant cured by reaction with moisture in the air. Both are products of Dow Corning Corp., Midland, Mich. Thermoplastic (hot melt) adhesives include Bemis 3218, a polyurethane-based hot melt adhesive, and Bemis 5251 a polyester-based hot melt adhesive, both produced by Bemis Associates, Shirley, Mass. Examples of adhesives that cure by solvent loss are Scotch Grip 1357, a neoprene adhesive from 3M Corp., St. Paul, Minn., and E6000, a butadiene rubber adhesive from Eclectic Products, Inc., Pineville, La. This list is exemplary and does not represent an exhaustive list of useful adhesives; others will be obvious to those skilled in the art.

The bipolar plates and the bipolar grids may be made of a variety of materials, including both metals and non-metals. Carbon may be used in any of its many forms including, for example, graphite, amorphous carbon, partially or fully graphitized carbon compositions, and carbon-carbon composites. Electronically conductive polymers, conductive polymer composites and insulating polymers may also be useful materials for portions of the bipolar elements. Conductive polymer composites include, for example, carbon-filled polymers and metal-filled polymers. The polymers may have either stochastic or ordered filling. Insulating polymers may be used for the bonding perimeter of a bipolar element when the bipolar element is fabricated with a central conducting region covering the area in closest proximity to the active electrode to provide the required electron conductance for the cell.

The solid electrolyte membranes used in the membrane and electrode assemblies may be made from a variety of ionically conducting polymers, such as, for example, single phase polymers, mixed phase polymers and matrix reinforced polymers. Single-phase polymers include perfluorosulfonic acid polymers (PFSA) and substituted trifluro polystyrenes. One example of matrix reinforced polymer is the GORE SELECT membrane produced by W.L. Gore and Associates of Newark, Del., which consists of a porous polytetrafluoroethylene matrix filled with a PFSA polymer.

While the materials for the solid electrolyte membranes listed above are quite common and may be used in the present invention, there are modifications that can be made to increase their usefulness. These modifications include treating the non-active perimeters of the membranes so that the membrane perimeters will remain dimensionally stable, with respect to moisture content, after being assembled in a bonded electrochemical cell stack. Treating the non-active perimeters is not required to successfully implement the present invention; an adequate bond can be produced with a non-stabilized membrane. The treatment is preferred, however, because the normal wetting and drying cycles of the membranes in an electrochemical cell stack cause stress to the membranes. The non-stabilized membranes expand and shrink with each wetting and drying cycle, which eventually weakens and breaks the adhesive bonds. Dimensionally stabilizing the membrane reduces the stresses produced by the wetting and drying cycles and thus prevents the bonds from weakening.

In a first alternative treatment for making a dimensionally stable membrane perimeter, a sheet of conventional PFSA polymer in the non-ionic sulfonyl fluoride form (formulated R—SO₂F) is masked, clamped or otherwise covered around the perimeter of the sheet forming a margin that is protected by the covering from reaction. The inner, unprotected portion of the membrane is then first hydrolyzed with a strong base, such as NaOH, to convert the inner portion to the ionomeric form, and then treated with a strong acid to convert the inner portion to the acid form. The significant reactions are illustrated in equations (1) and (2).

R—SO₂F+2NaOH→R—SO₃Na+NaF+H₂O (1)

R—SO₃Na+H₂SO₄→R—SO₃H+NaHSO₄ (2)

Alternatively, the perimeter of a PFSA membrane may be made dimensionally stable by converting just the perimeter of the fully protonated form of the membrane to the tetra-alkyl ammonium form. This conversion may be performed by contacting the perimeter of the sheet with a solution of a tetra-alkyl ammonium compound in the form of its hydroxide salt, such as, for example, tetrabutyl ammonium (TBA) hydroxide, as shown in equation (3). Other tetraalkyl ammonium compounds may be used having either symmetrical (all four alkyl substituents on the nitrogen atom identical) or asymmetrical (two or more different alkyl substituents on the nitrogen atom) structures.

R—SO₃⁻H⁺+(C₄H₉)₄NOH→R—SO₃⁻(C₄H₉)₄N⁺+H₂O (3)

Contacting the perimeter may be accomplished in several ways including, but not limited to, selectively immersing one edge of the membrane at a time into a solution of tetraalkyl ammonium hydroxide (TAH) in alcohol (preferably methanol) to a controlled depth or by immersing the entire membrane in the TAH alcohol solution after masking or otherwise protecting the central portion. The conversion of the perimeter area may be accomplished before or after the electrodes are attached to the membrane.

Yet another alternative for stabilizing the perimeter of the solid electrolyte to be bonded is to selectively convert the perimeter of the membrane from the proton form to a polyvalent cationic form. This conversion may be accomplished by contacting only the perimeter of the membrane with a basic solution of aluminum sulfate. The aluminum is absorbed by the membrane perimeter and becomes immobile. Once the membrane is converted to the polyvalent ion form, it absorbs less water and is more dimensionally stable to changes in moisture in its surroundings. In each of these methods of contacting only an unmasked or otherwise limited area of membrane to a treating solution, the high edge length to thickness ratio helps to limit the conversion to only the portion of the membrane in direct contact with the treating liquid.

It is not required that the membrane be dimensionally stabilized in the areas to be bonded with adhesive. Traditionally, membranes have not been bonded effectively either to other membranes or to other surfaces, such as bipolar elements, because the membranes are so thin and have such smooth surfaces. However, it has been determined that some epoxies may successfully bond these membranes to each other and to other surfaces. To be successful, the epoxy must be resilient, having flexibility with a hardness (Shore A) of between about 90 and about 70, preferably about 80. Furthermore, the tensile strength, which correlates closely to peel strength, should be between about 7500 psi and about 6500 psi. Elongation should be between about 5% and 8%, preferably between about 6% and 7%. An epoxy having these characteristics is DURALCO 4538N, a registered trademark of Cotronics Corporation of Buffalo, N.Y. Resilient epoxies frequently contain long aliphatic segments between the functional groups that polymerize to form the chains.

The perimeter of the membrane portion of the membrane and electrode assembly itself does not itself have to be directly bonded to the bipolar element but rather may be first bonded to at least one additional layer of membrane around the perimeter. This additional layer may then be bonded to the bipolar element. This may be accomplished by hot pressing a second sheet of membrane, having an open area congruent with the active area of the membrane and electrode assembly, to one side of the membrane. Alternatively an additional sheet of membrane, also having an open area congruent with the active area, may be hot pressed on the opposite side of the membrane. The additional sheets of membrane in the bonding area reinforce the membrane and electrode assembly and provide a better surface for adhesion to the bipolar elements. Alternatively, strips of membrane may be hot pressed, or otherwise bonded, to one or both sides of the perimeter of the membrane. As another alternative, strips of membrane may be hot pressed, or otherwise bonded, to only sections of one or both sides of the perimeter of the membrane.

An advantage of the present invention is that the repeating subassemblies of an electrochemical stack may be produced, stored until needed, and then assembled into the electrochemical stack. The present invention provides for bonding components of the repeating subassemblies together with an adhesive, testing the subassemblies and then storing the subassemblies until needed for assembling the electrochemical cell stack. A repeating subassembly may be a single membrane and electrode assembly bonded to a bipolar element or a repeating subassembly may be more complex with several electrochemical cells bonded together. A repeating subassembly may consist of two membrane and electrode assemblies bonded to opposing faces of a bipolar plate with provision for fluid cooling using either gas or liquid cooling. Many combinations of components forming subassemblies are useful so long as the subassemblies facilitate the final assembly of an electrochemical cell stack. The subassemblies may be assembled in the quantity needed to produce an electrochemical cell stack having the required number of electrochemical cells in series.

The subassemblies may be more complex than the examples given above or less complex. However, an advantage of the subassemblies is that they may be assembled, tested and stored until needed to assemble an electrochemical stack. Each subassembly may itself be a complete fuel cell stack with current collectors, bipolar plates and membrane and electrode assemblies. Furthermore, the adhesive bonding techniques described herein may be used to secure two or more subassemblies together.

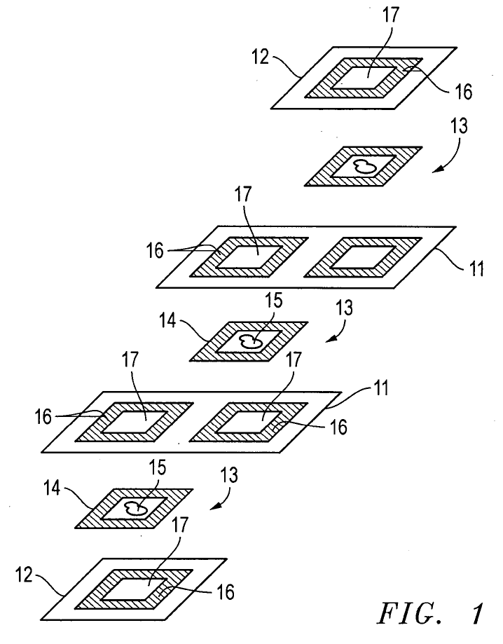

FIG. 1 is an exploded view of an exemplary monopolar electrochemical cell stack assembly using bipolar grids bonded with adhesive using the method of the present invention. The method of the present invention may be used to bond components of an electrochemical cell stack in a wide variety of configurations, including membrane and electrode assemblies having a wide variety of ion conducting membranes. Therefore, FIG. 1 is merely an exemplary arrangement and is not meant to limit the configuration of the component assembly. Dual cell frames 11 have openings 17 for exposing the membrane and electrode assemblies 13. The cell frames 11 sandwich the membrane and electrode assemblies 13 between them. Applying an adhesive to the sealing areas 14, 16 and pressing the cell frames 11 and membrane and electrode assemblies 13 together until the adhesive is fully cured bonds the cell frames and the membrane and electrode assemblies together. Preferably, the sealing area 14 of the membrane and electrode assembly 13 has been treated to dimensionally stabilize the sealing area 14. A single cell frame 12 is used on each end of the electrochemical cell stack assembly to span the lone cell on each end of the assembly.

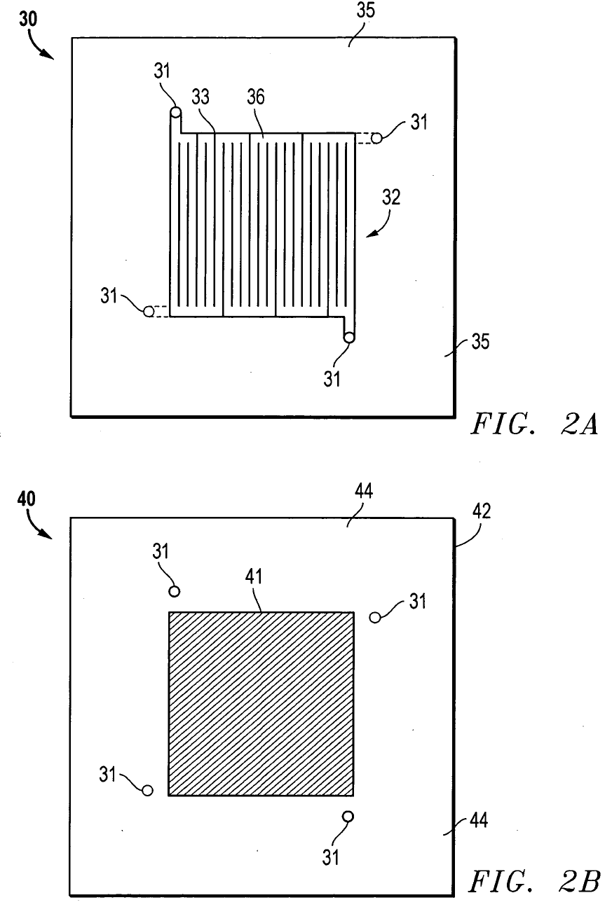

FIGS. 2A-2B are plan views of two subassemblies. FIG. 2A is a plan view of a typical bipolar plate 30. A flow field 32 is located in the central region of the bipolar plate 30. The flow field 32 includes ridges 33 and channels 36 through which the reactants flow. Manifolds 31 carry reactants, products, by-products and cooling fluids, if used, throughout the electrochemical cell stack, communicating fluids in and out of the stack. In this example, an anode side of the bipolar plate is shown. The opposite side of the bipolar plate is the cathode side, having a cathode flow field.

FIG. 2B is a plan view of a membrane and electrode assembly (MEA). The MEA 40 comprises an ion exchange membrane 42, such as a proton exchange membrane, with an anode electrode 41 attached or formed on one side of the membrane 42 and a cathode electrode 43 (See FIG. 2C) attached or formed on the opposite side of the membrane 42. Manifolds 31 are provided for the reactants to enter the appropriate flow fields in the bipolar plate and to exit with products and by-products. The electrodes 41, 43 are attached or formed on the ion exchange membrane 42. Optionally, an area 44 of the membrane 42 outside the active area established by the electrodes 41, 43 may be treated to provide dimensional stability of the membrane, and thereby provide a preferable bonding surface for adhesive application in accordance with the present invention.

FIG. 2C is a cross sectional view of two subassemblies 50 that are ready to be assembled in accordance with the present invention. An MEA 40 is bonded to one side of a bipolar plate 30 with an adhesive 51 around the perimeter of the members 40,30. The anode electrode 41 is positioned in contact with the anode flow field 32 of the bipolar plate 30. The subassemblies 50 are repeating subassemblies because they repeat through an electrochemical cell stack and the two repeating subassemblies 50 may be subsequently bonded together with adhesive to form a larger section of an electrochemical stack. The membrane area 44 around the exposed cathode electrode of one MEA 40, that has been optionally treated to become dimensionally stable may be bonded to the cathode side of the bipolar plate 30 of an adjacent subassembly 50 in accordance with the present invention.

### EXAMPLE 1

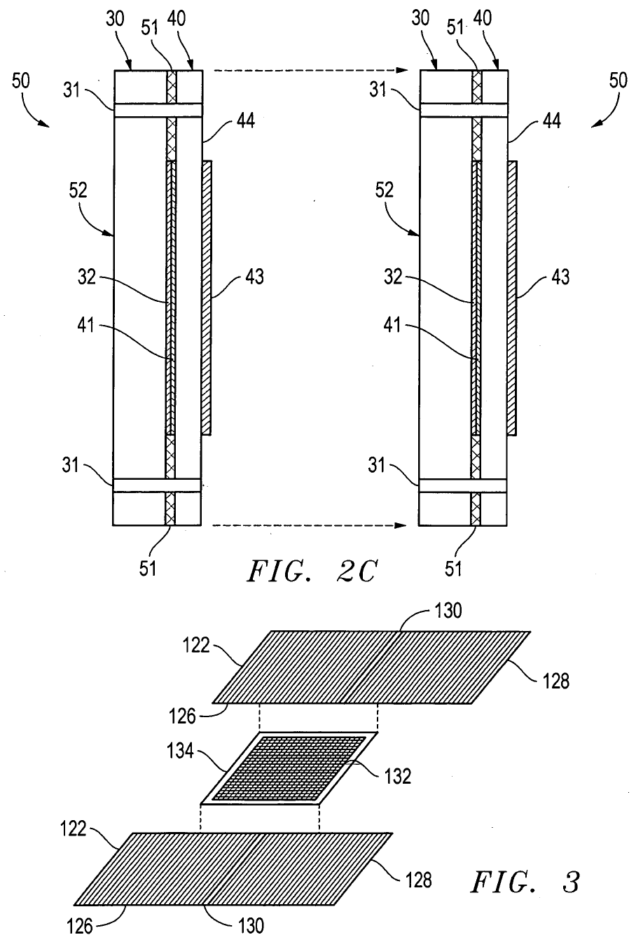

This example demonstrates the construction of a 15 W monopolar electrochemical fuel cell stack having cells constructed without cell frames as shown in FIG. 3 and described in U.S. Pat. No. 6,054,228, which is hereby fully incorporated by reference. Two metal grids 122 having gas diffusion structures disposed thereon are each divided into an anode side 128 and a cathode side 122. A gas barrier 130 disposed between them separates the anode side 128 and the cathode side 122. A membrane and electrode assembly 132, having a PTFE frame 134, is disposed between the cathode side and anode side of the two metal grids 122.

Sheets of expanded titanium screen, having a thickness of 0.005 in. (127 μm) with a fraction open area of about 50%, were cut into pieces and soaked in a degreaser as preparation for gold plating. After soaking for about twenty-four hours, the screens were rinsed with deionized water and then placed in a clean container with sufficient etching solution to completely cover the pieces. The etching solution is made up of one liter of deionized water, one gram of sodium fluoride, 5 ml of glacial acetic acid and 30 ml of concentrated hydrochloric acid. Care was taken to ensure that the pieces did not touch one another while they were immersed in the etching solution. When the pieces in the etching solution generated a continuous gentle bubble, they were removed from the etching solution and rinsed with deionized water. The pieces were then plated with platinum and then plated with gold using methods known in the art. The screens were cut to provide 12 bipolar screens, each bipolar screen measuring 7.2 cm×11 cm, and to provide 6 end screens, each end screen measuring 4.33 cm×11 cm. These provided enough material for three sub-stacks.

A paste was prepared for the gas diffusion matrix by blending a uniform mixture of equal parts of carbon fiber, carbon black, and Teflon dispersion together, and adding water and additional surfactant as needed to produce a smooth, creamy paste. The paste was applied, pressed and smoothed over each screen and then cured in an oven at 320° C. for 30 minutes. Excess paste was then removed from the edges and center of the pieces.

The cells were assembled using an adhesive seal with membrane and electrode assemblies having thin film electrodes previously applied and cured on NAFION 117 membranes. The adhesive used for assembling the fuel cell stack was DURALCO 4538N, a registered trademark of Cotronics Corporation of Brooklyn, N.Y. Equal parts of hardener and resin were mixed and then applied to the edges of the membrane, to the edges of the screen and to the inter-cell region of the bipolar screens to seal between the cathode and the anode, thereby creating the gas barrier. The components were then pressed together and the process was repeated for each cell.

A piece of Teflon release sheet was placed on either face of the cells and then the cells were clamped between two rigid plates to dry for about eight hours. The multi-cell assembly was then pressed between a pair of silicone rubber sheets at 160° C. for five minutes with a force of about 300 psi. A current collector wire was spot welded to the edges of the end screen and the stack was attached to a polycarbonate cell frame with the same adhesive and cured for about eight hours.

### EXAMPLE 2

### Hypothetical Example

A bipolar fuel cell stack may be assembled using the method of the present invention. A set of 19 bipolar plates with provision for supplying a liquid coolant to the core of each plate and two current collector plates are produced in accordance with to the teachings of Cisar et al, in U.S. Pat. No. 6,232,010, hereby incorporated by reference. A set of 20 membrane and electrode assemblies are produced with thin film electrodes applied and cured on a membrane. DURALCO 4538N adhesive is prepared as described in Example 1 and applied to the perimeter frame of the anode current collector taking care not to cover the reactant gas manifold and cooling fluid manifold, but including their perimeters. One of the MEAs is placed on the current collector plate and aligned with the anode flow field on the current collector plate, thereby adhesively bonding the perimeter of the membrane and electrode assembly to the current collector plate. Adhesive is applied to the perimeter of the cathode side of a bipolar plate, taking care not to cover the reactant gas manifold and cooling fluid manifold, but including their perimeters, and this bipolar plate is placed on top of the MEA with the cathode flow field aligned with the cathode electrode of the MEA. Adhesive is then applied to the anode face of the bipolar plate and the assembly process continues by repeating the steps as described until all 20 MEAs and the 19 bipolar plates have been used. The cathode current collector is then aligned and bonded to the stack in the same manner.

It will be understood from the foregoing description that various modifications and changes may be made in the preferred embodiment of the present invention without departing from its true spirit. It is intended that this description is for purposes of illustration only and should not be construed in a limiting sense. Only the language of the following claims should limit the scope of this invention.

What is claimed is:

1. A method for assembling an electrochemical subassembly comprising:
a) adhesively bonding an anode side of a membrane and electrode assembly to an anode side of a bipolar grid; and
b) adhesively bonding a cathode side of the membrane and electrode assembly to a cathode side of an additional bipolar grid, wherein an adhesive provides a fluid-tight seal between the grids and the membrane and electrode assembly.

2. The method of claim 1, further comprising
c) adhesively bonding an anode side of an additional membrane and electrode assembly to an anode side of the additional bipolar grid;
d) adhesively bonding a cathode side of the additional membrane and electrode assembly to a cathode side of an additional bipolar plate; and
e) repeating steps c and d until a pre-determined number of membrane and electrode assemblies have been adhesively bonded.

3. The method of claim 1, wherein the membrane and electrode assembly comprises a solid polymer electrolyte membrane having a cathode electrode formed on a first side of the membrane and an anode electrode formed on a second side of the membrane.

4. The method of claim 3, wherein the solid electrolyte membrane is a material capable of conducting ions selected from single phase polymers, mixed phase polymers or matrix reinforced polymers.

5. The method of claim 4, wherein the ions conducted by the polymer are cations.

6. The method of claim 1, further comprising
dimensionally stabilizing a perimeter of the membrane and electrode assembly.

7. The method of claim 6, wherein the step of dimensionally stabilizing a perimeter further comprises:
converting a central portion of a sheet of PFSF polymer to an acid form;
forming an anode and a cathode on opposing sides of the central portion of the sheet.

8. The method of claim 6, wherein the membrane is initially fully protonated, the step of dimensionally stabilizing the perimeter further comprises:
converting the perimeter of the membrane to a tetra-alkyl ammonium form.

9. The method of claim 8, further comprising:
contacting the perimeter with an alcohol solution of a tetra-alkyl ammonium salt, wherein the tetra-alkyl ammonium is selected from symmetrical and asymmetrical structures.

10. The method of claim 9, wherein the tetra-alkyl ammonium salt is a hydroxide.

11. The method of claim 9, wherein the tetra-alkyl ammonium salt dissociates to a cation having a form (NR′R″R′″R″″)⁺, wherein R′, R″, R′″, and R″″ are identical.

12. The method of claim 9, wherein the tetra-alkyl ammonium salt dissociates to a cation having a form (NR′R″R′″R″″)⁺, wherein R′ and R″ are identical and different from R′″ and R″″.

13. The method of claim 9, wherein the tetra-alkyl ammonium salt dissociates to a cation having a form (NR′R″R′″R″″)⁺, wherein R′, R″, R′″, R″″ are different from each other.

14. The method of claim 6, wherein the step of dimensionally stabilizing the perimeter further comprises:
converting the perimeter of the membrane to a polyvalent cationic form.

15. The method of claim 6, wherein the step of dimensionally stabilizing the perimeter further comprises:
contacting the perimeter with a basic solution of aluminum sulfate.

16. The method of claim 3, further comprising:
bonding an additional layer of a membrane to the perimeter on at least one side of the membrane and electrode assembly.

17. The method of claim 16, wherein the bonding is a process selected from hot pressing and applying an adhesive.

18. The method of claim 16, wherein the additional layer is dimensionally stabilized.

19. The method of claim 1, wherein the bonding perimeters of the bipolar grids are of material selected from metal, carbon, electronically conductive polymers, conductive polymer composites or insulating polymers.

20. The method of claim 1, wherein the adhesive is an adhesive type selected from reactively cured, thermoplastic, and cured by solvent loss.

21. The method of claim 1, wherein the adhesive is an epoxy having a hardness (Shore A) of between about 90 and about 70.

22. The method of claim 1, wherein the adhesive is an epoxy having a hardness (Shore A) of about 80.

23. A method for assembling an electrochemical stack subassembly comprising:
a) adhesively bonding an anode side of a membrane and electrode assembly to an anode side of a bipolar element; and
b) adhesively bonding a cathode side of the membrane and electrode assembly to a cathode side of an additional bipolar element, wherein an adhesive provides a fluid-tight seal between the bipolar element and the membrane and electrode assembly.

24. The method of claim 23, wherein the bipolar element is selected from a bipolar plate or a bipolar grid.

25. The method of claim 23, further comprising:
applying adhesive to a perimeter of a feature on the bipolar element, wherein the feature is selected from a flow field, a manifold, a channel, and combinations thereof.

26. The method of claim 23, further comprising:
c) adhesively bonding an anode side of an additional membrane and electrode assembly to an anode side of the other bipolar element;
d) adhesively bonding a cathode side of the additional membrane and electrode assembly to a cathode side of an additional bipolar element; and
e) repeating steps c and d until a pre-determined number of membrane and electrode assemblies have been adhesively bonded.

27. The method of claim 23, wherein the membrane and electrode assembly comprises a solid polymer electrolyte membrane having a cathode electrode formed on a first side of the membrane and an anode electrode formed on a second side of the membrane.

28. The method of claim 27, wherein the solid electrolyte membrane is a material capable of conducting ions selected from single phase polymers, mixed phase polymers or matrix reinforced polymers.

29. The method of claim 28, wherein the ions conducted by the polymer are cations.

30. The method of claim 23, further comprising:
dimensionally stabilizing a perimeter of the membrane and electrode assembly.

31. The method of claim 30, wherein the step of dimensionally stabilizing a perimeter further comprises:
converting a central portion of a sheet of PFSF polymer to an acid form;
forming an anode and a cathode on opposing sides of the central portion of the sheet.

32. The method of claim 30, wherein the membrane is initially fully protonated, the step of dimensionally stabilizing the perimeter further comprises:
converting the perimeter of the membrane to a tetra-alkyl ammonium form.

33. The method of claim 32, further comprising:
contacting the perimeter with an alcohol solution of a tetra-alkyl ammonium salt, wherein the tetra-alkyl ammonium is selected from symmetrical and asymmetrical structures.

34. The method of claim 33 where in the tetra-alkyl ammonium salt is a hydroxide.

35. The method of claim 33, wherein the tetra-alkyl ammonium salt dissociates to a cation having a form (NR′R″R′″R″″)⁺, wherein R′, R″, R′″, and R″″ are identical.

36. The method of claim 33, wherein the tetra-alkyl ammonium salt dissociates to a cation having a form (NR′R″R′″R″″)⁺, wherein R′ and R″ are identical and different from R′″ and R″″.

37. The method of claim 33, wherein the tetra-alkyl ammonium salt dissociates to a cation having a form (NR′R″R′″R″″)⁺, wherein R′, R″, R′″, R″″ are different from each other.

38. The method of claim 30, the step of dimensionally stabilizing the perimeter further comprises:
converting the perimeter of the membrane to a polyvalent cationic form.

39. The method of claim 30, the step of dimensionally stabilizing the perimeter further comprises:
contacting the perimeter with a basic solution of aluminum sulfate.

40. The method of claim 27, further comprising:
bonding an additional layer of a membrane to the perimeter of at least one side of the membrane and electrode assembly.

41. The method of claim 40, wherein the bonding is a process selected from hot pressing and applying an adhesive.

42. The method of claim 40, wherein the additional layer is dimensionally stabilized.

43. The method of claim 23, further comprising
adhesively bonding a final anode bipolar element spanning only an anode side of a membrane and electrode assembly;
adhesively bonding a final cathode bipolar element spanning only a cathode side of a membrane and electrode assembly.

44. The method of claim 23, wherein the bonding perimeters of the bipolar elements are of material selected from metal, carbon, electronically conductive polymers, conductive polymer composites or insulating polymers.

45. The method of claim 23, wherein the adhesive is an adhesive type selected from types consisting of reactively cured, thermoplastic, and cured by solvent loss.

46. The method of claim 23, wherein the adhesive is an epoxy having a harness (Shore A) of between about 90 and about 70.

47. The method of claim 23, wherein the adhesive is an epoxy having a hardness (Shore A) of about 80.

48. The method of claim 23, wherein the adhesive is a silicone material.

49. The method of claim 23, wherein the adhesive is a polyurethane.

50. The method of claim 23, wherein the adhesive is a thermoplastic selected from polyalkylenes, polyethylene containing copolymers, polypropylene, polypropylene containing copolymers, polyesters and polyarethanes.

51. A method for assembling an electrochemical cell stack comprising:
adhesively bonding components for subassemblies of an electrochemical cell stack; and
adhesively bonding the subassemblies needed for an electrochemical stack, wherein the components for the subassemblies are selected from bipolar plates, bipolar grids, membrane and electrode assemblies, cooling plates, heating plates, or combinations thereof.

52. The method of claim 51, further comprising:
storing the subassemblies.

53. The method of claim 51, wherein the subassemblies form at least one repeating unit within the electrochemical cell stack.

54. The method of claim 51, wherein an adhesive provides a seal for all fluids contacting the adhesive when the stack is in operation.

55. A subassembly for an electrochemical cell stack comprising:
a bipolar element;
a membrane and electrode assembly, wherein a perimeter of the membrane and electrode assembly is dimensionally stabilized;
an adhesive bond, wherein the adhesive bond provides a fluid-tight seal between the bipolar element and the membrane and electrode assembly.

56. The subassembly of claim 55, wherein the bipolar element is selected from a bipolar plate, a bipolar grid, a heating plate, a cooling plate, and combinations thereof.

57. The subassembly of claim 55, wherein the membrane and electrode assembly comprises:
a solid polymer electrolyte membrane;
a cathode electrode formed on a first side of the membrane; and
an anode electrode formed on a second side of the membrane.

58. The subassembly of claim 57, wherein the solid electrolyte membrane is a material capable of conducting ions selected from single phase polymers, mixed phase polymers or matrix reinforced polymers.

59. The subassembly of claim 57, wherein the solid polymer electrolyte membrane further comprises:
a perimeter of PFSF polymer;
a central portion of PFSF polymer converted to an acid form.

60. The subassembly of claim 55, wherein a perimeter of the membrane and electrode assembly is of a tetra-alkyl ammonium form.

61. The subassembly of claim 55, wherein a perimeter of the membrane and electrode assembly is of a polyvalent cationic form.

62. The subassembly of claim 55, further comprising an additional layer of a membrane to a perimeter on at least one side of the membrane and electrode assembly.

63. The subassembly of claim 62, wherein the additional layer is dimensionally stabilized.

64. The subassembly of claim 55, wherein the bonding perimeters of the bipolar element is made of material selected from metal, carbon, electronically conductive polymers, conductive polymer composites or insulating polymers.

65. The subassembly of claim 55, wherein the adhesive bond is formed by an adhesive type selected from reactively cured, thermoplastic, and cured by solvent loss.

66. The subassembly of claim 55, wherein the adhesive bond is formed by an epoxy having a hardness (Shore A) between about 90 and 70.

67. A method for assembling an electrochemical subassembly comprising:
a) adhesively bonding an anode side of a membrane and electrode assembly to an anode side of a bipolar element;
b) adhesively bonding a cathode side of the membrane and electrode assembly to a cathode side of an additional bipolar element, wherein the adhesive provides a fluid-tight seal between the bipolar element and the membrane and electrode assembly; and
c) using an epoxy having a hardness (Shore A) of between about 90 and 70 for adhesive bonding.

68. The method of claim 67, wherein the bipolar element is selected from a bipolar plate or a bipolar grid.

69. The method of claim 67, further comprising:
applying adhesive to a perimeter of a feature on the bipolar element, wherein the feature is selected from a flow field, a manifold, a channel, and combinations thereof.

70. The method of claim 67, further comprising:
d) adhesively bonding an anode side of an additional membrane and electrode assembly to an anode side of the other bipolar element;
e) adhesively bonding a cathode side of the additional membrane and electrode assembly to a cathode side of an additional bipolar element; and
e) repeating steps c through e until a pre-determined number of membrane and electrode assemblies have been adhesively bonded.

71. The method of claim 67, wherein the membrane and electrode assembly comprises a solid polymer electrolyte membrane having a cathode electrode formed on a first side of the membrane and an anode formed on a second side of the membrane.

72. The method of claim 71, wherein the solid electrolyte membrane is a material selected from single phase polymers, mixed phase polymers or matrix reinforced polymers.

73. The method of claim 71, wherein a perimeter of the membrane is dimensionally stabilized.

74. A subassembly for an electrochemical cell stack comprising:
a bipolar element;
a membrane and electrode assembly;
an adhesive bond, wherein the adhesive bond provides a fluid-tight seal between the bipolar element and the membrane and electrode assembly.

75. The subassembly of claim 74, wherein the bipolar element is selected from a bipolar plate, a bipolar grid, a heating plate, a cooling plate, and combinations thereof.

76. The subassembly of claim 74, wherein the membrane and electrode assembly comprises:
a solid polymer electrolyte membrane;
a cathode electrode formed on a first side of the membrane; and
an anode electrode formed on a second side of the membrane.

77. The subassembly of claim 76, wherein the solid electrolyte membrane is a material capable of conducting ions selected from single phase polymers, mixed phase polymers or matrix reinforced polymers.

78. The subassembly of claim 76, wherein a perimeter of the membrane and electrode assembly is dimensionally stabilized.

79. The subassembly of claim 76, wherein the solid polymer electrolyte membrane further comprises:
a perimeter of PFSF polymer;
a central portion of PFSF polymer converted to an acid form.

80. The subassembly of claim 78, wherein a perimeter of the membrane and electrode assembly is of a tetra-alkyl ammonium form.

81. The subassembly of claim 78, wherein a perimeter of the membrane and electrode assembly is of a polyvalent cationic form.

82. The subassembly of claim 74, further comprising an additional layer of a membrane to a perimeter on at least one side of the membrane and electrode assembly.

83. The subassembly of claim 82, wherein the additional layer is dimensionally stabilized.

84. The subassembly of claim 74, wherein the bonding perimeters of the bipolar element is made of material selected from metal, carbon, electronically conductive polymers, conductive polymer composites or insulating polymers.

85. The subassembly of claim 74, wherein the adhesive bond is formed by an adhesive type selected from reactively cured, thermoplastic, and cured by solvent loss.

86. The subassembly of claim 74, wherein the adhesive bond is formed by an epoxy having a hardness (Shore A) between about 90 and 70.
